(19) United States
(12) Patent Application Publication
(10) Pub. No.: US 2017/0094035 A1
(43) Pub. Date: Mar. 30, 2017

(54) MANAGEMENT METHOD AND MANAGEMENT DEVICE

(71) Applicant: Panasonic Intellectual Property Management Co., Ltd., Osaka (JP)

(72) Inventors: TOMONORI NAKAMURA, Osaka (JP); HIROO ISHIKAWA, Kanagawa (JP); KUNIO NAKATSUKASA, Kyoto (JP); SHIKI KOU, Osaka (JP)

(21) Appl. No.: 15/271,200

(22) Filed: Sep. 20, 2016

(30) Foreign Application Priority Data
Sep. 29, 2015 (JP) 2015-192192

(51) Int. Cl. H04L 29/06; H04L 12/28; H04L 29/08

(52) U.S. Cl. CPC H04L 69/18; H04L 67/142; H04L 12/2809

(57) ABSTRACT

A method for a device connected to a first control device and a second control device, including: transmitting a command for causing a first device to execute a predetermined operation, the first device being controlled by the first control device; transmitting a command for causing the first device to transmit first information indicating a state of the first device after the predetermined operation is executed; transmitting a third command for causing a second device to transmit second information indicating a state of the second device; receiving the first information and the second information; comparing the first information and the second information; and storing, in a memory, third information indicating the first device is controlled by the first control device and the second control device when the first device is determined to be the second device based on the first information and the second information.

### BACKGROUND

1. Technical Field

The present disclosure relates to a management method and a management device with which the identities of devices indicated by a plurality of identifications (IDs) are determined.

2. Description of the Related Art

There are conventionally known systems in which a server device in a cloud and a device such as a home appliance or a sensor installed in the household of a user (hereinafter, also referred to as a household device or simply as a device) are connected via a communication network such as the Internet, and the user uses a mobile terminal capable of connecting to the Internet to remotely control the household device via the server device.

A large number of connection schemes (communication protocols) for communication in this kind of cloud-based remote control system for household devices have been proposed such as ECHONET Lite (registered trademark). However, it is often the case that the technical specifications (control protocols) of services provided by the manufacturing vendors (hereinafter, simply referred to as vendors) of each household device in order to control the household devices in this kind of remote control system are decided by the vendors themselves. Therefore, in a conventional remote control system, interconnection among a plurality of vendors has been difficult even with a common connection scheme.

This problem regarding interconnection can be solved by constructing a system in such a way that an integration server device that integrates server devices used by vendors to provide their services is setup in a cloud and this integration server device controls the server devices of the vendors. With this system, the user can control a household device made by any vendor via a service operated on the integration server device.

However, in this system, in the case where the same household device is connected to a plurality of server devices of different vendors, control signals are transmitted by way of a plurality of routes from the integration server device to the household device. Therefore, there is a possibility that control requests transmitted close to each other in terms of time to the same household device via different routes may compete with each other (for example, power on and power off). In order to avoid this, it is necessary to verify the identities of household devices indicated by device IDs managed by the different server devices.

Japanese Unexamined Patent Application Publication No. 2004-86792 discloses a technique in which an inspection is performed regarding whether or not fault information notified to a cloud server in a cloud from a plurality of routes is substantially the same. In Japanese Unexamined Patent Application Publication No. 2004-86792, household devices notify fault information to a cloud server via a plurality of routes. If the difference in the reception time of the fault information received from each of the routes is less than a predetermined value, the cloud server determines that the false information indicates the same event.

### SUMMARY

However, additional determination criteria has been required in order to reliably determine the identities of household devices indicated by a plurality of device IDs that are indicated by information received from a plurality of routes.

In one general aspect, the techniques disclosed here feature a management method in a management device connected to a first control device and a second control device, the management method including: transmitting a first command for causing a first device to execute a predetermined operation, to the first control device, and the first device being controlled by the first control device; transmitting a second command for causing transmission of first information indicating a state of the first device after the predetermined operation has been executed, to the first control device; receiving the first information from the first control device; transmitting a third command for causing transmission of second information indicating a state of the second device, to the second control device; receiving the second information from the second control device; comparing the first information and the second information; determining that the first device is the same as the second device when the state indicated by the second information corresponds to the state indicated by the first information; and the first device storing third information indicating that the first device is controlled by the first control device and the second control device, in a memory.

According to the abovementioned aspect, in an integration server device that integrates a plurality of server devices, the identities of household devices independently managed by the server devices are determined. On the basis of the result of this determination, it is possible to prevent the occurrence of control requests that compete for the same household device from a plurality of services.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view depicting a configuration of a device control system that includes an integration server device in an embodiment;

FIG. 2A is a block diagram depicting an example of a functional configuration of a first server device and a second server device in the embodiment;

FIG. 2B is a block diagram depicting an example of a functional configuration of an integration server device in the embodiment;

FIG. 3 is a block diagram depicting an example of a functional configuration of a device management unit provided in the integration server device in the embodiment;

FIG. 4 is a drawing depicting an example of a device table that retains device IDs of household devices connected to the integration server device in the embodiment, and results of determining the identities of the household devices indicated by a plurality of the device IDs;

FIG. 5A is a drawing depicting an example of a control procedure table that retains control procedures for determining the identities of household devices indicated by device IDs;

FIG. 5B is a drawing depicting an example of a control procedure table that retains control procedures for determining the identities of household devices indicated by device IDs;

FIG. 6 is a flowchart depicting an example of a procedure from starting the registration of a household device to determining the identity of a device indicated by a device ID in the embodiment;

FIG. 7 is a drawing depicting an example of a notification presented to a user by a control terminal when the registration of a device is started;

FIG. 8 is a flowchart depicting an example of a procedure in which the integration server device in the embodiment acquires a list of household devices connected to a LAN within a user household;

FIG. 9 is a drawing depicting an example of a device list transmitted from each control device to the integration server device in the embodiment;

FIG. 10 is a drawing depicting an example of a device list managed within the integration server device in the embodiment;

FIG. 11 is a flowchart depicting an example of a procedure for determining whether a device ID acquired by the integration server device is not registered, in the embodiment;

FIG. 12 is a flowchart depicting an example of a procedure for verifying device IDs in the determining of the identities of household devices indicated by device IDs in the embodiment;

FIG. 13 is a drawing depicting an example of a notification presented to the user by the control terminal in relation to a device operating when the identities of household devices indicated by device IDs are being determined;

FIG. 14 is a flowchart depicting an example of a procedure for comparing the states of household devices in the determining of the identities of household devices indicated by a plurality of device IDs;

FIG. 15A is a flowchart depicting an example of a procedure for converting abstract control requests that are not dependent upon control devices, into specific control requests that are dependent upon control protocols used in control devices, in the determining of the identities of household devices indicated by a plurality of device IDs;

FIG. 15B is a flowchart depicting an example of a procedure for converting specific control responses that are dependent upon control protocols used in control devices, into abstract control responses that are not dependent upon control devices, in the determining of the identities of household devices indicated by a plurality of device IDs;

FIG. 16 depicts an example of a command conversion table for converting abstract control content and specific control content in the determining of the identities of household devices indicated by a plurality of device IDs;

FIG. 17 depicts an implementation example of an integration interface in a protocol conversion unit; and

FIG. 18 depicts an example of conversion into control requests corresponding to each control device by the protocol conversion unit.

### DETAILED DESCRIPTION

### (Findings Forming the Basis for the Present Disclosure)

Techniques have been studied for providing a service for device control aimed at devices owned by users regardless of the vendor, by using a server device in a cloud. However, with an increase in the number and types of services, there has been an increase in the possibility of the same device being simultaneously controlled by a plurality of services. In particular, it is difficult to continuously execute services in a stable manner when a plurality of items of control implemented simultaneously with respect to the same device are competing.

This kind of simultaneous control of the same device by a plurality of services can be prevented by prohibiting control of a device from another service while the device is being controlled from a certain service. In order to realize this prevention, assurance is required that the IDs indicating control-target devices correspond with each device on a one-to-one basis.

However, the ID systems used for the server devices of the vendors to identify devices are not uniform among the vendors. Therefore, among a plurality of vendors, there is a possibility that different IDs may be used for the same device or the same ID may be used for different devices. A method for determining the identities of devices indicated by IDs that have been assigned to devices in different systems such as these has not been studied. Therefore, situations occur in which IDs indicate the same device despite actually being different devices, or IDs indicate different devices despite actually being the same device.

In the method of Japanese Unexamined Patent Application Publication No. 2004-86792, the identity of an event indicated by fault information is determined depending only on the proximity of the reception time thereof. However, in device control, responses from devices corresponding to single items of device control reach an integration server device at generally the same time despite taking different routes. Consequently, it is difficult to determine the identities of devices by depending only on the time at which information from devices is received at the integration server device. Here, there is an issue of adding further improvements in order to determine the identities of devices.

Hence, the present inventor studied the following remedial measures.

(1) A management method according to an aspect of the present disclosure is a management method for a management device connected to a first control device and a second control device, the management method including: transmitting a first command to the first control device for causing a first device to execute a predetermined operation, and the first device being controlled by the first control device; transmitting a second command to the first control device for causing transmission of first information indicating a state of the first device after the predetermined operation has been executed; receiving the first information from the first control device; transmitting a third command for causing transmission of second information indicating a state of the second device, to the second control device; receiving the second information from the second control device; comparing the first information and the second information; determining the first device is the second device when the state of the second device indicated by the second information corresponds to the state of the first device indicated by the first information; and the first device storing, in a memory, third information indicating the first device is controlled by the first control device and the second control device when the first device is determined to be the second device.

It is thereby possible to detect that devices being controlled by different control devices are the same device. Furthermore, on the basis of this determination result, it is possible to avoid control by different control devices and the occurrence of competition for control among mutually different devices.

(2) In the abovementioned aspect, the first device may be controlled by the first control device by way of a first protocol, and the second device may be controlled by the second control device by way of a second protocol different from the first protocol.

It is thereby possible to determine the identity of a device even when the systems for control requests used by a plurality of control devices are different.

(3) In the abovementioned aspect, the first information may include a first value, the second information may include a second value, and the first device may be determined to be the second device when an absolute value of the difference between the first value and the second value is within a predetermined range.

It is thereby possible to determine the identity of a device even in the case where it is possible for a value to be set to a neighboring value of a value in a control request according to a determination made by each device, as with a temperature setting, for example.

(4) In the abovementioned aspect, in addition, fourth information indicating an initial state of the first device is received before the first command is transmitted, and a fourth command for causing the first device to be restored to the initial state indicated by the fourth information is transmitted to the first control device after at least the first information has been received.

It is thereby possible to restore a device from a device state that is the result of a control request that is not intended by the user and has been executed in order to determine an identity, to a device state brought about by control based upon an operation implemented by the user prior to the determination.

(5) In the abovementioned aspect, in addition, fourth information indicating an initial state of the first device may be received before the first command is transmitted, and the predetermined operation may be decided based upon the initial state indicated by the fourth information.

Thus, while a user is using a device, it is possible to ensure that control that is outside of the usage purpose of the user is not carried out by the management device with respect to the device. In the case where an air conditioner is being used in a cooling operation by a user, it is possible to prevent the air conditioner from being switched to a heating operation or a dehumidifying operation. Consequently, when a control request for determining an identity is issued, it is possible to avoid a control request having content with which inconvenience or discomfort is forced upon the user. Furthermore, it is possible to suppress an increase in the power consumed by a device due to following control for determining an identity.

(6) In the abovementioned aspect, in addition, a user terminal associated with the first device may be notified of the first device executing the predetermined operation, before the first command is transmitted.

The user thereby receives notice regarding the start of or an alteration in the operation of a device. As a result, it is possible to prevent a sense of uneasiness being caused for a user due to an unexpected device operation.

(7) In the abovementioned aspect, the memory may store fourth information in advance, and the fourth information may indicate a device connected to the management device and, in addition, may indicate that the device connected to the management device is controlled by at least one of the first control device and the second control device.

It is thereby possible for the management device to grasp the corresponding relationship between a device under the management thereof and a control device that controls that device.

(8) In the abovementioned aspect, in addition, a fourth command for causing transmission of fifth information may be transmitted to the first control device, the fifth information indicating devices controlled by the first control device, the fifth information may be received from the first control device, the fourth information and the fifth information may be compared, and the first command may be transmitted when the first device is not included in the fourth information as a device controlled by the first control device.

It is thereby possible to determine the identity of a device only in the case where the corresponding relationship between a device and a control device that controls that device has not already been stored. Consequently, it is possible to suppress an increase in the power consumed by a device due to following control for determining an identity.

(9) In the abovementioned aspect, the fifth information may additionally indicate the types of the devices controlled by the first control device, and, in addition, when the first device is included in a first type, the predetermined operation may be decided based upon the first type.

These general and specific aspects may be implemented using a system, a method, and a computer program, and any combination of systems, methods, and computer programs.

It should be noted that the embodiments described hereinafter all represent specific examples of the present disclosure. The numerical values, the shapes, the constituent elements, the steps, the order of the steps, and so forth given in the following embodiments are examples and are not intended to restrict the present disclosure. Furthermore, from among the constituent elements in the following embodiments, constituent elements that are not described in the independent claims representing the most significant concepts are described as optional constituent elements. Furthermore, in all of the embodiments, it is also possible to combine the respective content thereof.

It should be noted that the word “household device” used in the present application includes the concept of electronic devices such as home appliances and sensors installed within the household of a user as mentioned above. Furthermore, “household” mentioned here is not restricted to an indoor area in which the user is staying or living, and, for example, refers to an area covered by one local area network (hereinafter, referred to as a LAN) or a virtual LAN to which the user connects a device in the residence thereof.

Furthermore, the word “user” used in the present application may refer to individual users or may collectively refer to one or more users who use a household device in one user household. Which definition of user is being referred to depends on whether individual users or individual user households are being used as management units by the device management apparatus and the control devices, and these may be mixed. It is possible to apply the present disclosure in either case.

Hereinafter, an embodiment will be described in a specific manner with reference to the drawings.

### (Embodiment)

### [Overall Configuration]

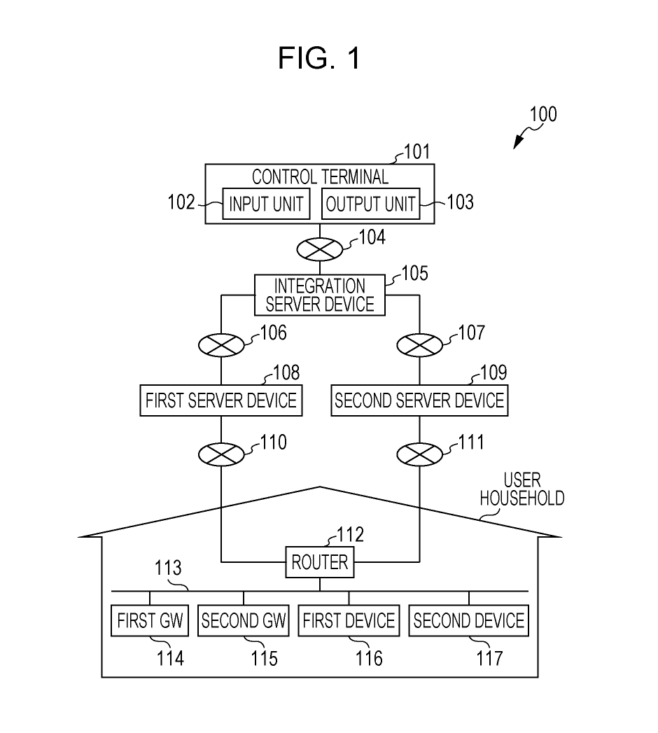

First, an example of the overall configuration of a device control system in an embodiment will be described. FIG. 1 is a drawing schematically depicting a configuration of a device control system 100 that includes a device management apparatus according to an aspect of the present disclosure.

The device control system 100 in the present embodiment includes a control terminal 101, an integration server device 105, a first server device 108, a second server device 109, a router 112, a LAN 113, a first gateway (denoted by GW in the drawings) 114, a second gateway 115, a first device 116, and a second device 117.

Hereinafter, an embodiment will be described with these constituent elements being envisaged as follows. The control terminal 101 is in an arbitrary location. The integration server device 105, the first server device 108, and the second server device 109 are virtual servers or physical servers configured in a cloud. The router 112, the LAN 113, the first gateway 114, the second gateway 115, the first device 116, and the second device 117 are in the household of a user. From among these constituent elements, the control terminal 101, the integration server device 105, the first server device 108, the second server device 109, and the router 112 are connected by networks 104, 106, 107, 110, and 111, which are wide area networks (hereinafter, referred to as WANs) such as the Internet. Furthermore, the first gateway 114, the second gateway 115, the first device 116, and the second device 117 are connected to the LAN 113, which is a local area network installed in the household, and are connected to the abovementioned wide area network via the router 112 connected to the LAN 113. It should be noted that the control terminal 101 may be connected to this WAN via the router 112 in the household of the user. Furthermore, the networks 104, 106, 107, 110, and 111 may not be separate, and all or some may be connected to each other to configure one large network. Furthermore, all of the networks 104, 106, 107, 110, and 111 may constitute a portion of the Internet.

The control terminal 101 is preferably a terminal such as a cellular phone like a smartphone, a tablet, or a personal computer, or may alternatively be a navigation system or a remote controller for a household device that can be directly or indirectly connected to the WAN. The control terminal 101 is an example of a terminal associated with the user, in the present embodiment.

The control terminal 101 is provided with an input unit 102 that receives input for a control request from the user to household devices by means of a finger-based operation, speech, or the like, and an output unit 103 that presents the user with information such as the state of the device control system 100 or each household device by means of images, light, speech, vibrations, or the like, or a combination of these. The user inputs a control request to a household device via a general-purpose web browser installed in the control terminal 101, for example, and receives information such as the state of the household device. Instead of this web browser, an application for controlling a household device provided by the vendor of the household device or the like may be used.

The integration server device 105 is an example of a device management apparatus in the present embodiment. The first server device 108 and the second server device 109 are examples of control devices in the present embodiment, and, hereinafter, no distinction is made between the first server device 108 and the second server device 109, or these are collectively referred to as control devices. The integration server device 105, the first server device 108, and the second server device 109 will be described later on.

The first device 116 and the second device 117 are household devices and, in the present embodiment, are examples of devices that are controlled by the abovementioned control devices. Hereinafter, no distinction is made between the first device 116 and the second device 117, or these are collectively referred to as household devices or simply as devices. The first device 116 and the second device 117 are electronic devices such as an air conditioner, an illumination device, a refrigerator, a microwave oven, a cooking heater, an electric lock, an electric shutter, a person-detecting sensor, a temperature sensor, a humidity sensor, or an air quality sensor, for example.

The first gateway 114 and the second gateway 115 (hereinafter, no distinction is made between these, or these are collectively referred to as gateways) relay cooperation between the household devices and the control devices. The gateways acquire the states of the household devices, for example, and notify the states to the control devices. Furthermore, the gateways transmit control requests transmitted from the control devices to the household devices. The control mentioned here, for example, refers to turning power sources for the household devices on/off, and setting alterations for a set temperature if a household device is an air conditioner, brightness if a household device is an illumination device, or the like.

It should be noted that these gateways are provided from each vendor of the household devices, for example. That is, when the household devices in one user household are made up of products of a plurality of vendors, there are a plurality of gateways in the user household as depicted in FIG. 1. Each gateway may retain settings for connecting to the control device operated by the vendor in question. In the following description of the present embodiment, a scenario is assumed in which the first server device 108 communicates with only the first gateway 114 from among the two gateways, and communicates with each household device via the first gateway 114. Furthermore, a scenario is assumed in which the second server device 109 communicates with only the second gateway 115 from among the two gateways, and communicates with each household device.

Furthermore, the gateways may carry out a safety confirmation by means of authenticating access from a control device, for example. This kind of control and authentication for household devices may be realized according to specifications stipulated as a connection scheme such as ECHONET Lite.

Furthermore, authentication for communication between a gateway and a household device may be carried out. Each household device is thereby able to receive only control requests from an authenticated partner gateway. For example, authentication may be carried out only between the first device and the first gateway such that it is not possible for the first device to be controlled from the second gateway. In this way, the combinations of gateways and household devices with which communication is possible may be restricted. It should be noted the present disclosure is intended to solve a problem that may occur in the case where each household device is able to communicate with a plurality of control devices, and, in the description of the present embodiment hereinafter, a scenario is assumed in which the combinations of gateways and household devices with which communication is possible are not particularly restricted.

Such gateways may be provided as a device integrated with the router 112 described later on or a household device, or as software that operates in the router 112 or a household device.

Furthermore, there are two of each of the gateways and the household devices in FIG. 1; however, the present embodiment can also be applied when there are three or more.

The LAN 113 is a local area network installed in the household as mentioned above, and connects the router 112, the first gateway 114, the second gateway 115, the first device 116, and the second device 117. The LAN 113 may be wired or wireless. Furthermore, the LAN 113 may include a plurality of different communication schemes. For example, the first gateway 114 and the first device 116 may be connected by a wireless LAN based upon IEEE 802.11, the second gateway 115 and the second device 117 may be connected by Bluetooth, and the first gateway 114, the second gateway 115, and the router 112 may be connected by a wired LAN that uses Ethernet. However, in the case where the LAN 113 is configured as in this example, it is not possible to control the second device 117 from the first gateway 114 or the control first device 116 from the second gateway 115.

The router 112 provides a function for connecting the LAN 113 and a WAN such as the Internet.

It should be noted that one user household is depicted in FIG. 1 for the purpose of the description, and it is assumed that the device control system 100 is used by a plurality of users. That is, in the same way as the user household in FIG. 1, there is a router 112 in each of a plurality of user households provided with household devices and gateways connected by a LAN 113, and the router 112 connects the LAN 113 to the control devices via the networks 110 or 111.

The first server device 108 and the second server device 109 constituting control devices in the present embodiment are virtual servers or physical servers configured in a cloud as mentioned above, and a service that includes the exchange of control requests, control responses, notifications, and the like is provided in such a way that a user of the device control system 100 is able to control a household device in the user household from outside of the user household. Here, a functional configuration of the first server device 108 and the second server device 109 will be described with reference to the drawings.

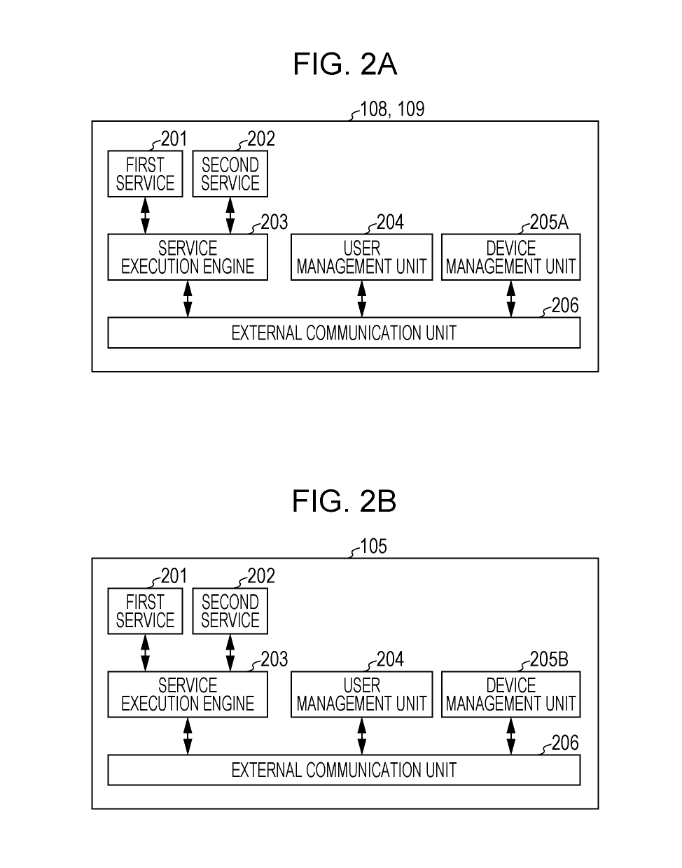

FIG. 2A is a block diagram depicting an example of a functional configuration common to the first server device 108 and the second server device 109. Each control device is provided with a first service 201, a second service 202, a service execution engine 203, a user management unit 204, a device management unit 205A, and an external communication unit 206. It should be noted that the integration server device 105 basically also has a common functional configuration; however, the integration server device 105 will be described later on focusing on differences with the control devices.

The first service 201 and the second service 202 are applications for controlling the household devices, and are written in a language such as Java (registered trademark), JavaScript (registered trademark), or Hyper Text Markup Language (HTML) 5. Hereinafter, no distinction is made between the first service 201 and the second service 202, or these are collectively referred to as services.

The service execution engine 203 is an engine that manages the activation and termination of each service, and interprets and executes control requests from each service.

The user management unit 204 manages, using a user list, information regarding users who can use the services. Examples of the information included in this user information are usernames, passwords, and other information used for authentication. Furthermore, information relating to the control terminal 101 used to control each user household device (such as the model, type of operating system, browser version or dedicated application version, or a number or address constituting an information transmission destination) and information relating to the gateways used in the user household (such as the vendor, firmware version, or address constituting an information transmission destination) may be included in association with each user. Furthermore, the user management unit 204 may use the username, password, or the like to authenticate a user as required.

The device management unit 205A manages household devices that are connected via the network 110 or 111, using IDs that indicate each household device and are not duplicated among the control devices. Furthermore, the device management unit 205A cooperates with the user management unit 204 and associates and manages each user and the devices owned by the user in question. It should be noted that, in the following description, it is assumed that the control protocols used to control each household device are not common between the first server device 108 and the second server device 109, and the systems for control request commands and control response messages that are exchanged with each household device and the systems for IDs that are assigned to each household device are different. This is the scenario that exists in the case where each control device is operated by a different vendor, for example.

The external communication unit 206 communicates with the integration server device 105 via the network 106, and communicates with the router 112 via the network 110 or the network 111.

There are two control devices depicted in FIG. 1, namely the first server device 108 and the second server device 109; however, it should be noted that the present embodiment can also be applied when there are three or more.

The integration server device 105, which is an example of a device management apparatus in the present embodiment, is a virtual server or physical server configured in a cloud as mentioned above, and receives control instructions based upon user input, from the control terminal 101 via the network 104.

Furthermore, the integration server device 105 issues, to each control device, control requests or state acquisition requests for household devices under the management thereof, in accordance with control instructions received from the control terminal 101 for example, or information received from the control devices. These requests are implemented in a format (control request commands) that corresponds to the control protocol of each control device. Furthermore, information (control response messages) relating to the state of a household device acquired from the control devices is converted into a common format in order to perform a comparison. The details of this conversion will be described later on.

Furthermore, the integration server device 105 collects device IDs that have been assigned to the household devices within the user household in accordance with the different systems in the plurality of control devices, determines the identities of the devices indicated by the device IDs, and retains these determination results. These results are used in order to avoid the occurrence of competition for control of the household devices. This identity determination will be described later on.

It should be noted that, when the combinations of gateways and household devices with which communication is possible are restricted, the integration server device 105 selects a control device capable of communicating with a household device targeted for a control request and issues various control requests.

A functional configuration of this kind of integration server device 105 is depicted in FIG. 2B. As depicted in FIG. 2B, the functional configuration of the integration server device 105 is basically common with that of the first server device 108 and the second server device 109. However, the external communication unit 206 has different communication routes and counterparts, and communicates with the control terminal 101 via the network 104 and communicates with the control devices via the network 106 and the network 107. Furthermore, a device management unit 205B determines the identities of the abovementioned devices and saves the results thereof in a storage device. The function relating to this identity determination is a function performed by the integration server device 105 in the device control system 100 in the present embodiment. Hereinafter, the device management unit 205B of the integration server device 105 in the present embodiment will be described with reference to the drawings.

### [Functional Configuration of Device Management Unit of Integration Server Device]

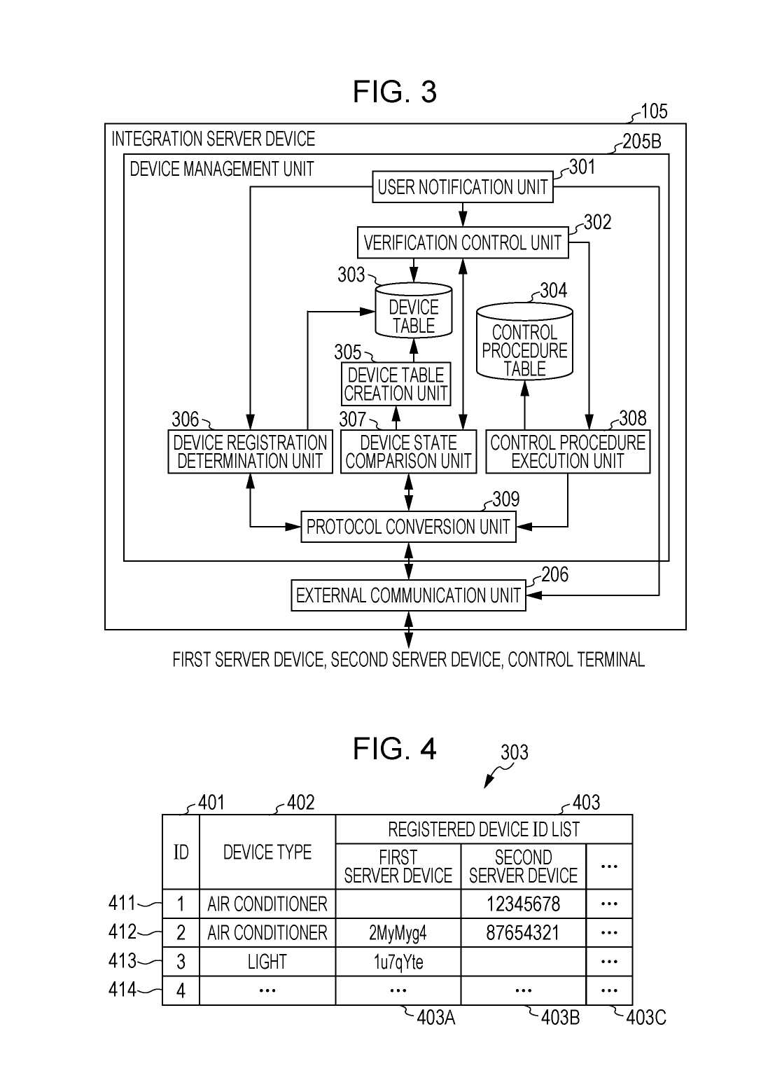

FIG. 3 is a block diagram depicting an example of a functional configuration of the device management unit 205B of the integration server device 105. Configurations other than the device management unit 205B and the external communication unit 206 from among the constituent elements depicted in FIG. 2B have been omitted in FIG. 3.

The device management unit 205B of the integration server device 105 is provided with a user notification unit 301, a verification control unit 302, a device table 303, a control procedure table 304, a device table creation unit 305, a device registration determination unit 306, a device state comparison unit 307, a control procedure execution unit 308, and a protocol conversion unit 309.

The user notification unit 301 notifies the user that device control is to be carried out for the abovementioned identity determination, and is configured by a Hyper Text Transfer Protocol (HTTP) server, HTML documents, and the like.

The verification control unit 302 controls the device state comparison unit 307 and the control procedure execution unit 308 described later on, and determines the identities of household devices indicated by a plurality of device IDs notified from the control devices. A detailed procedure for this identity determination performed by the verification control unit 302 is described later on.

The device table 303 is an example of management information in the present embodiment, which retains device IDs of household devices that are connected to the integration server device 105 via the control devices and results of the abovementioned identity determination. Hereinafter, the device table 303 will be described with reference to the example depicted in FIG. 4.

The IDs in column 401 are device IDs that are assigned to each household device so as to be unique in the integration server device 105. The device types in column 402 indicate the types of household devices (air conditioner, light, and the like). The registered device ID list 403 is a list that retains device IDs of the household devices notified from the control devices, on the basis of the control device that notified each device ID and the household device indicated by each device ID. Device IDs in the same column have been notified from the same control device. In the example of FIG. 4, those retained in column 403A are device IDs that have been notified from the first server device 108, and those retained in column 403B are device IDs that have been notified from the second server device 109. In the case where device IDs are received from control devices other than these, the device IDs are retained in such a way that one column is formed for the device ID notified from each control device in column 403C and thereafter.

Furthermore, across the whole of the device table 303, device IDs retained in the same row are device IDs that have been determined as indicating the same household device by means of the identity determination. Taking row 412 as an example, it is shown that the household device to which the ID of “2” has been assigned in the integration server device 105 has a device type of an air conditioner, and the device ID “2MyMyg4” notified from the first server device 108 and the device ID “87654321” notified from the second server device 109 indicate this air conditioner. It should be noted that in the case where the result of a determination indicates that a device ID has not been notified from any of the control devices in the past and is an unregistered household device, the device ID is retained in row 414 or thereafter in such a way that information relating to one household device forms one row. It should be noted that these device IDs are examples of device identifiers in the present embodiment.

Furthermore, there may also be blank sections in the registered device ID list 403 such as the section in row 413, column 403B. This blank section means that an ID indicating the same device as the device indicated by the device ID “1u7qYte” notified from the first server device 108 has not been notified from the second server device 109.

It should be noted that the device management unit 205B of the integration server device 105 may cooperate with the user management unit 204 provided in the integration server device 105, and associate and manage each user with the devices owned by the user in question. For example, the device table 303 may be prepared for each user, and each user and the device table 303 relating to the devices owned by the user in question may be associated using information uniquely indicating users for whom information is managed by the user management unit 204. Alternatively, a column that retains information uniquely indicating users may be provided in the device table 303, and the rows and the users may be made to correspond. In the present embodiment, FIG. 4 is described under the assumption of being a device table 303 that relates to the devices owned by one user.

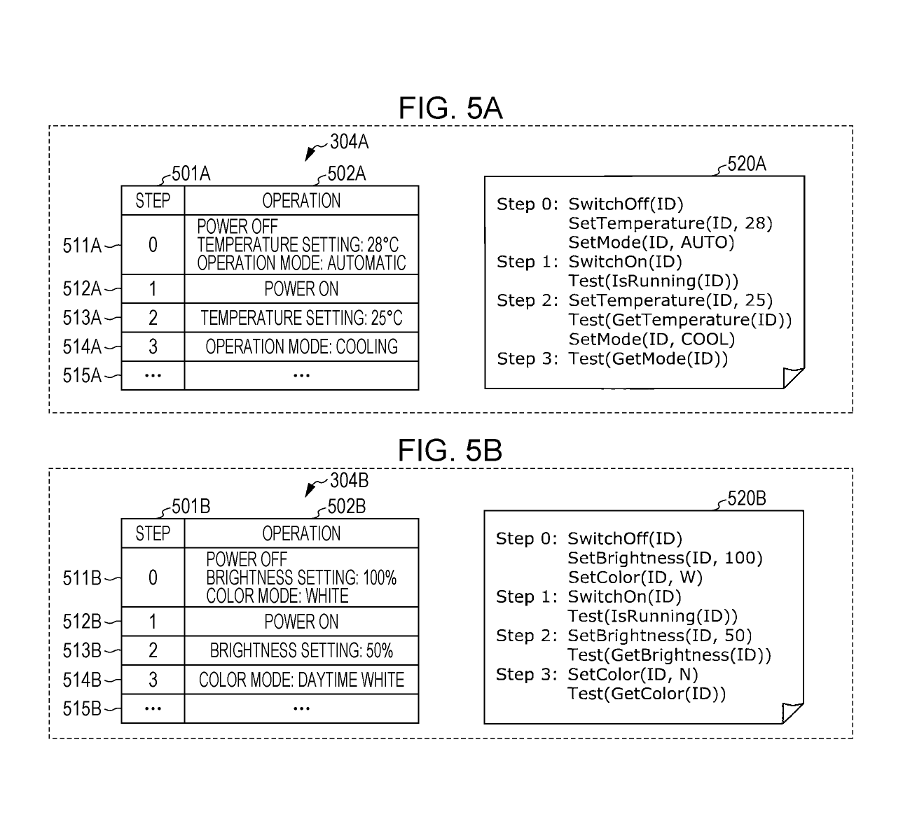

The control procedure table 304 retains, for each device type, a control procedure for determining the identities of devices indicated by a plurality of device IDs. The device types mentioned here are common with the device types in column 402 in the device table 303. FIG. 5A depicts a control procedure table 304A that is an example of the control procedure table 304 and indicates a control procedure for determining the identity of a household device having a device type of an air conditioner. FIG. 5B depicts a control procedure table 304B that is an example of the control procedure table 304 and indicates a control procedure for determining the identity of a household device having a device type of a light. The numerals in column 501A and column 501B indicate the order of the steps in each control procedure. Step 0 is preprocessing that is carried out prior to a determination, for example, and step 1 and thereafter are executed in numerical order as control for the determination. The operations in column 502A and column 502B are operation content that is executed in each step. It should be noted that depicted to the right of each table in FIG. 5A and FIG. 5B are examples of a command list for causing the household devices to execute the series of steps in the control procedure table 304. These commands will be described later on in a description of an identity determination procedure. It should be noted that no distinction is made between column 501A and column 501B, or the columns corresponding to these in the control procedure table 304 are collectively referred to as column 501. Furthermore, no distinction is made between column 502A and column 502B, or the columns corresponding to these in the control procedure table 304 are collectively referred to as column 502.

The device table creation unit 305 updates the device table 303 on the basis of the result of a determination performed by the device state comparison unit 307 described later on. A detailed operation of the device table creation unit 305 will be described later on in a subsequent description of an identity determination procedure.

The device registration determination unit 306 determines the registration statuses of household devices connected to the LAN 113 in the user household. A detailed operation of the device registration determination unit 306 will be described later on in a subsequent description of an identity determination procedure.

The device state comparison unit 307 determines the identities of household devices indicated respectively by a plurality of IDs by, after the control procedure execution unit 308 described later on has performed control of a household device, acquiring information indicating the states of household devices that may possibly be the same by way of a plurality of routes and comparing the acquired information. A detailed operation of the device state comparison unit 307 will be described later on in a subsequent description of an identity determination procedure.

In order to determine the identities of household devices indicated respectively by a plurality of IDs, the control procedure execution unit 308 implements device control of a household device in accordance with the content of the control procedure table 304 via the first server device 108 or the second server device 109, which are control devices. A detailed operation of the control procedure execution unit 308 will be described later on in a subsequent description of an identity determination procedure.

The protocol conversion unit 309 is a means for converting device control requests from the control procedure execution unit 308 into a format suitable for the control protocol of each control device, and converting control responses written in the control protocols used by each control device and received from each control device via the external communication unit 206, into a common format. A detailed operation of the protocol conversion unit 309 will be described later on in a subsequent description of an identity determination procedure.

### [Identity Determination Procedure]

Next, a procedure for determining the identities of household devices indicated by a plurality of device IDs notified from different control devices, carried out by the device management unit 205B, will be described using the drawings.

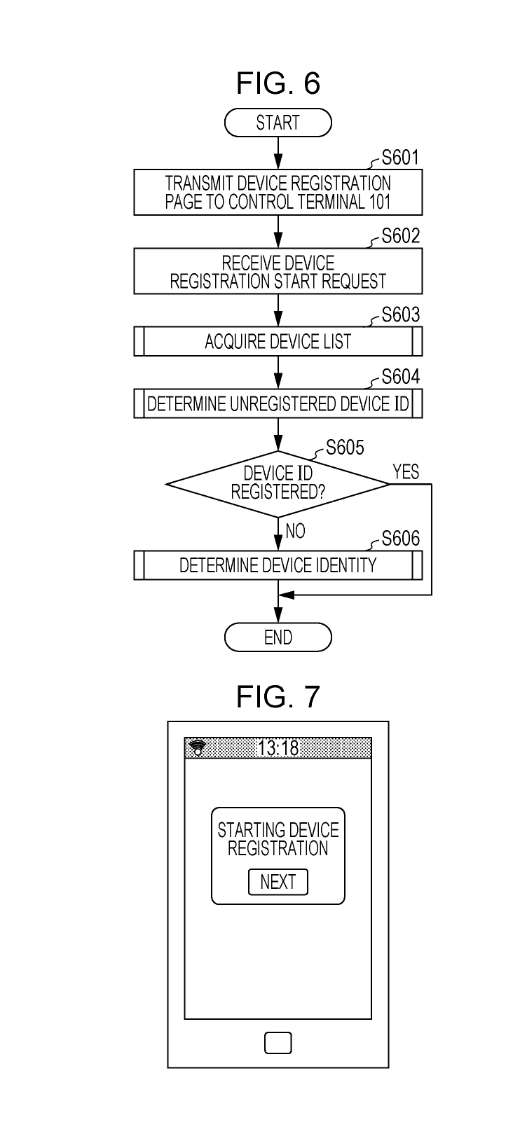

FIG. 6 is a flowchart depicting a series of example procedures from starting the registration of a household device, through to determining an unregistered device ID, and up to determining the identity of the household device indicated by the device ID, in the integration server device 105.

An unregistered device ID here means a device ID that has not been registered in the device table 303 of the integration server device 105 prior to execution of these procedures. However, the household device indicated by this unregistered device ID may already be registered in the device table 303 under a different device ID. In order to determine whether this is the case, the identity of the household device is determined.

First, in the device management unit 205B, the user notification unit 301 transmits a device registration page to the control terminal 101 via the external communication unit 206 (step S601). Step S601 is executed in response to a request from the control terminal 101, for example, or may be executed in response to a notification from a gateway via a control device. In order to execute a notification to the control terminal 101 in step S601 or thereafter, the user notification unit 301 may refer to user information managed by the user management unit 204 of the integration server device 105, as required.

The control terminal 101 displays this device registration page via the output unit 103, and receives input from the user via the input unit 102. FIG. 7 displays an example of the device registration page. This device registration page, for example, is one of the HTML documents that make up the abovementioned user notification unit 301. When the user presses the “next” button on this device registration page, a device registration start request is transmitted from the control terminal 101 to the user notification unit 301. The user notification unit 301 receives this device registration start request transmitted from the control terminal 101 (step S602).

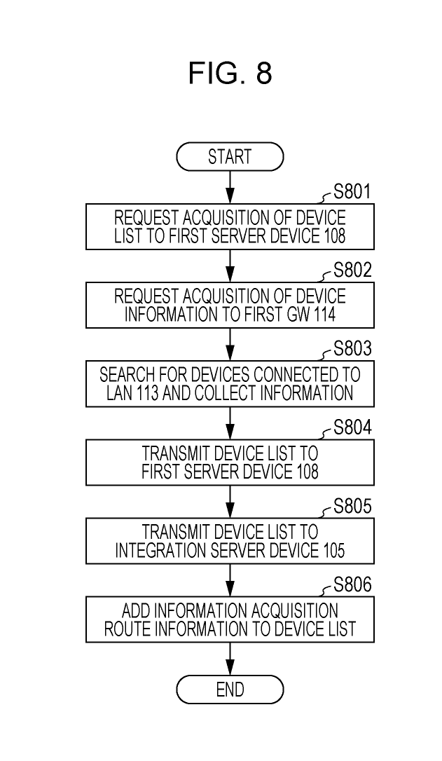

Next, the device registration determination unit 306 acquires a list of household devices connected to the LAN 113 within the user household (hereinafter, referred to as a device list) (step S603). In the case where step S601 has been executed in response to a request from the control terminal 101, a request destination for this device list is specified with reference to the user information managed by the user management unit 204 in the integration server device 105. An example of a detailed procedure for the processing in step S603 is depicted in the flowchart in FIG. 8. In this example, it is assumed that the request-destination control device is the first server device 108. The processing of step S603 is executed according to a similar procedure also in the case where the request destination is the second server device 109.

First, the device registration determination unit 306 requests the control device to acquire the device list via the protocol conversion unit 309 and the external communication unit 206 (step S801). The command that requests acquisition of the device list differs depending on the control protocol of the request-destination control device. Therefore, the protocol conversion unit 309 converts the device list acquisition request from the device registration determination unit 306 according to the control protocol of the request-destination control device. A detailed processing procedure of the protocol conversion unit 309 will be described later on.

Next, the first server device 108 having received this request to acquire the device list requests the first gateway 114 to acquire device information (step S802).

Next, the first gateway 114 having received this request to acquire device information searches for devices connected to the LAN 113 and collects information of each device (step S803). This search is executed by, for example, commands for confirming the presence of each device being transmitted by the first gateway 114 to the devices connected to the LAN 113 by broadcast communication (broadcasting) and responses from each device being received. Information collected from each device includes, for example, the device type and information specific to each household device (for example, a media access control (MAC) address). This device type is an example of type information for identifying the type of a device, and is also used in each control device and the integration server device 105.

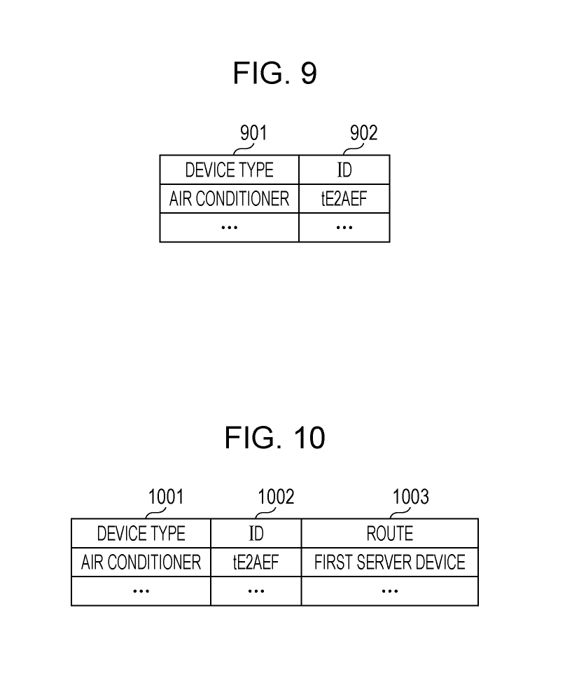

Next, the first gateway 114 transmits information of each household device connected to the LAN 113 collected due to the search, to the first server device 108 as a device list (step S804). FIG. 9 is an example of the device list transmitted from the first gateway 114 to the first server device 108 in step S804. The device types in column 901 indicate the device types (air conditioner, light, and the like) identified due to the search. The IDs in column 902 are IDs that are assigned to each device. These IDs are identifiers assigned by the first gateway 114. These IDs may, for example, be consecutive numbers in accordance with the order in which the information has been collected up to the present time, or a character string obtained by using a hash function to convert information specific to each household device such as a MAC address as mentioned above may be assigned.

Next, the first server device 108 transmits the received device list to the integration server device 105 (step S805). The device list transmitted here is substantially the same as the device information received from the first gateway 114 depicted in FIG. 9. In the integration server device 105, this device list is acquired by the device registration determination unit 306.

Next, the device registration determination unit 306 adds, to the device list received from the first server device 108, information indicating the control device that is the transmission source of the device list, namely the first server device 108 in this example, as information acquisition route information (step S806). It should be noted that in the case where a plurality of control devices are requested to acquire device lists, a transmission-source control device can be specified on the basis of the IP address of the transmission source associated with the received data, for example. An example of a device list to which information acquisition route information has been added is depicted in FIG. 10. Column 1001 and column 1002 are respectively the same as column 901 and column 902 in FIG. 9. Column 1003 includes information indicating the control device that is the transmission source of the device list. In the case of a device list acquired from the second server device 109, information indicating the second server device 109 is added in column 1003. It should be noted that information indicating the transmission-source control device may be included in a device list by each control device and transmitted to the integration server device 105.

The next procedure in the integration server device 105 will be described with reference to FIG. 6 once again.

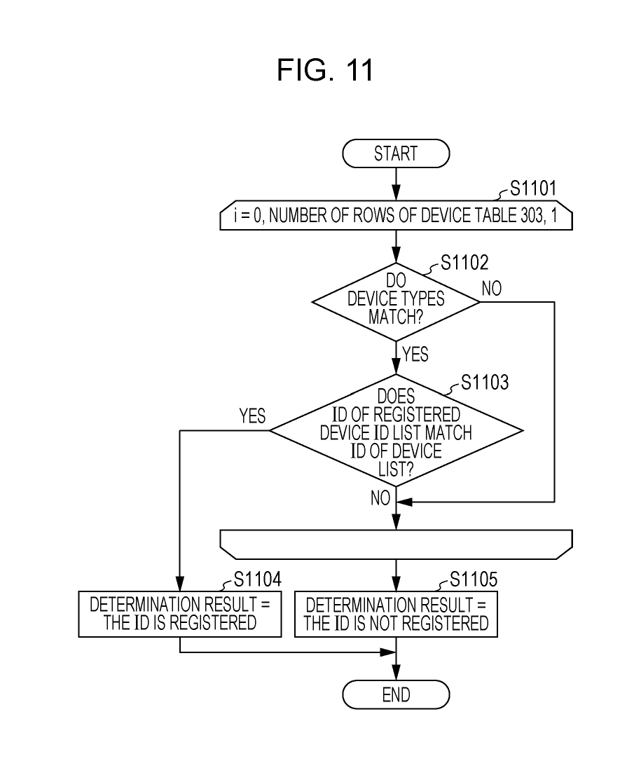

Next, the verification control unit 302 determines whether the device ID of each household device in the device list acquired in step S603 is an unregistered device ID (step S604). A detailed flowchart of the processing in step S604 is depicted in FIG. 11.

The verification control unit 302 repeatedly executes the following step S1102 and step S1103 with respect to each row of the device table 303 (step S1101).

First, it is determined whether the device type in column 402 in the i^{th} row in the device table 303 depicted in FIG. 4 and the device type in column 1001 in the device list depicted in FIG. 10 match (step S1102). To give a specific example, when i=1, the device type in column 402 in row 411 in the device table 303 of FIG. 4 and the device type in column 1001 in the device list of FIG. 10 are verified against one another.

In the case where these device types match (“yes” in step S1102), it is determined whether there is a device ID that matches the device ID in column 1002 in the device list, in the column corresponding to the route in column 1003 of the device list, within the registered device ID list 403 in the i^{th} row of the device table 303 (step S1103). In the verification in step S1102 exemplified above, the device types are both “air conditioner” and therefore match (“yes” in step S1102). In this case, it is determined whether there is a device ID that matches the device ID in column 1002 of the device list, in the column corresponding to the route in column 1003 of the device list, namely the “first server device”, in column 403A in the depicted example, within the registered device ID list 403 in row 411 in the device table 303. A determination is not made regarding matching with device IDs in other columns of the registered device ID list 403. That is, a determination is not made regarding matching with device IDs assigned by other control devices. The load and time required for the processing for the determination of step S1103 is thereby suppressed. Furthermore, even if there are coincidently matching device IDs among the device IDs assigned by the other control devices, these are not determined as having been registered.

In the case where the result of this determination is that column 403A contains a device ID that matches the device ID in column 1002 of the device list (“yes” in step S1103), the device indicated by the device ID in column 1002 of the device list is determined as having been registered (step S1104) and the determination regarding whether there is an unregistered device ID ends. Alternatively, in the case where the device list includes information in a plurality of rows, a determination regarding whether the device ID indicated in the next row is an unregistered device ID may be executed.

In the case where it is determined in step S1102 or step S1103 that there is no match (“no” in step S1102 or “no” in step S1103), step S1102 and step S1103 are repeated with respect to the next row (i+1^{th} row) of the device table 303. In the case where “no” is determined in step S1102 or step S1103 with respect to all of the rows, it is determined that the device ID in question has not been registered (step S1105) and the determination regarding whether there is an unregistered device ID ends.

In the depicted example, none of the rows in the registered device ID list 403 of FIG. 4 contain a device ID that matches the device ID “tE2AEF” in the device table of FIG. 10 (“no” in step S1103). Consequently, it is determined that the device ID “tE2AEF” is an unregistered device ID.

The next procedure in the integration server device 105 will be described with reference to FIG. 6 once again.

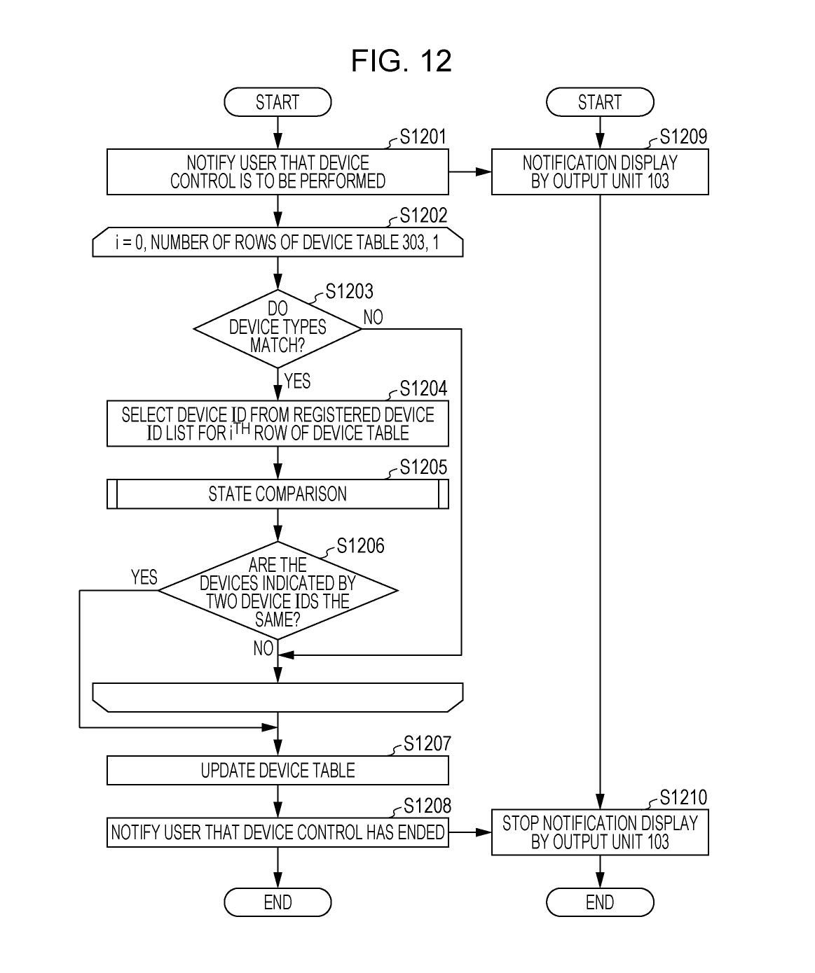

Next, the verification control unit 302 confirms the result of the determination of step S604 (step S605). In the case where the result of step S604 is that the device ID is registered (“yes” in step S605), the processing according to the series of procedures ends. In the case where the result of step S604 is that the device ID is not registered (“no” in step S605), the verification control unit 302, in addition, carries out identity determination processing between a device indicated by a registered device ID acquired from another control device and the device indicated by the unregistered device ID in question (step S606). A detailed flowchart of the processing in step S606 is depicted in FIG. 12.

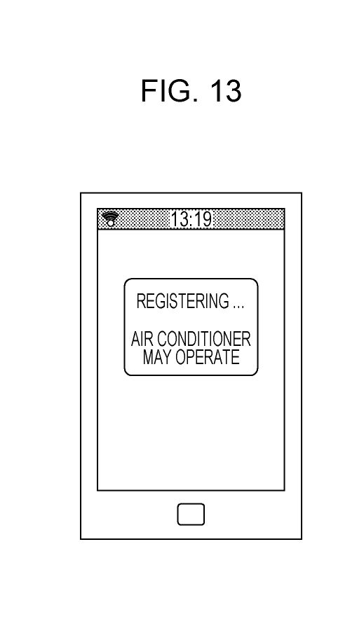

First, the verification control unit 302 instructs the control terminal 101 to notify the user that the household device is to be controlled and operated in order to determine the identity, via the user notification unit 301 (step S1201). The control terminal 101 having received this instruction presents the notification to the user via the output unit 103 (step S1209). For example, the user notification unit 301 transmits an HTML document, which is to be displayed as the notification that the household device is to be controlled and operated, to the control terminal 101, and causes the control terminal 101 to display this HTML document. This kind of notification page is also one of the HTML documents that make up the abovementioned user notification unit 301. An example of the case where this notification is displayed on a screen is depicted in FIG. 13.

Next, the verification control unit 302 repeats the following step S1203 to step S1206 with respect to each row of the device table 303 (step S1202).

First, the verification control unit 302 determines whether the device type in column 402 of the i^{th} row in the device table 303 depicted in FIG. 4 and the device type in column 1001 in the device list depicted in FIG. 10 match (step S1203). For example, in the case where i=1, the device types match with “air conditioner”.

In the case where these device types match (“yes” in step S1203), one device ID is selected from the registered device ID list 403 in the i^{th} row of the device table 303 and acquired (step S1204). It should be noted that in the case where a plurality of device IDs are already included in the registered device ID list 403 in the i^{th} row, a device ID may be randomly selected from thereamong. If the case where i=1 is taken as an example here again, the verification control unit 302 acquires the device ID “12345678” from column 403B.

It should be noted that in the case where the entirety of the registered device ID list 403 in the i^{th} row has already been filled due to the results of past determinations, the procedures of step S1203 and thereafter may be executed for the i+1^{th} row without executing the procedures of steps S1205 and S1206 for the i^{th} row. A state in which the registered device ID list 403 in the i^{th} row has already been filled refers to when the determination of the identities of the devices has been completed for all routes. Consequently, it is possible for the identity determination procedure to be omitted for household devices for which device IDs have been registered in this row, and for the determination of identities to be completed more promptly. Furthermore, it is possible to suppress a consumption of power by a device following control for determining an identity.

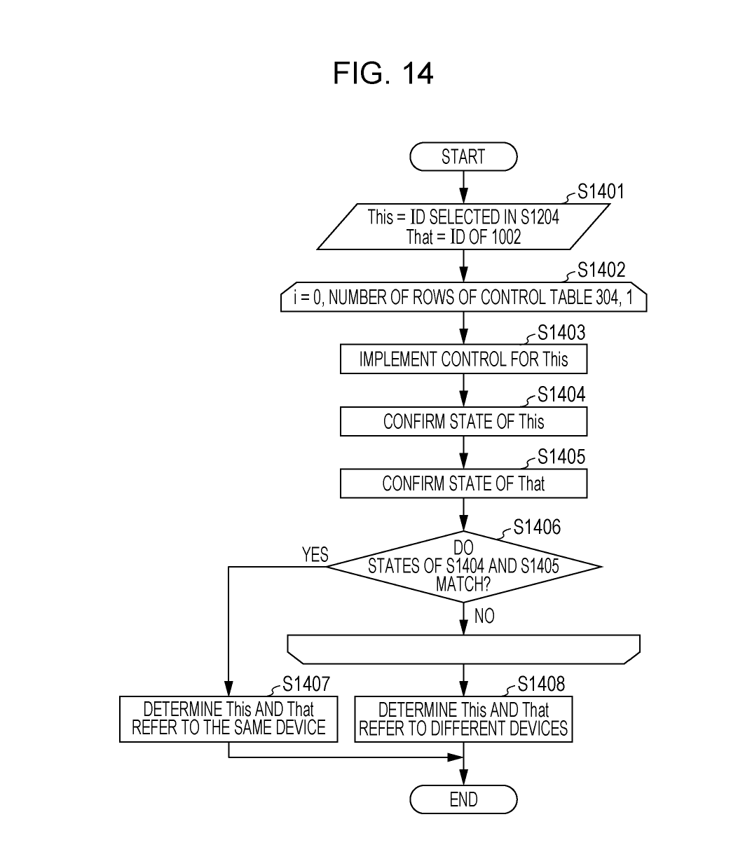

Next, the verification control unit 302 performs experimental control on the household device indicated by the device ID selected in step S1204, and acquires and compares information indicating the state of that device from a plurality of routes (step S1205). A detailed flowchart of the procedure of step S1205 is depicted in FIG. 14.

First, a variable This is initialized as the device ID selected in step S1204, and a variable That is initialized as the ID of 1002 in FIG. 10 (step S1401). In the abovementioned example up to the step S1203, This is initialized as value of the device ID “12345678” and That is initialized as the value of the device ID “tE2AEF”. The verification control unit 302 then causes the control procedure execution unit 308 and the device state comparison unit 307 to execute step S1403 to step S1407 with respect to each row of the control procedure table 304 (step S1402).

The verification control unit 302 transmits the device type determined as matching in step S1203 and the variable This to the control procedure execution unit 308. The control procedure execution unit 308 having received the device type and the variable This performs control for determining the identity of the household device indicated by the device ID of the variable This (step S1403).

Specifically, first, the control procedure execution unit 308 acquires the control procedure table 304. For this control procedure table 304, the control procedure table corresponding to the device type determined as matching in step

S1203 is acquired. In this example, the control procedure table 304A depicted in FIG. 5A, which is a control procedure table corresponding to the “air conditioner” device type, is acquired. This device type is an example of type information for identifying a type of a device.

Next, a control request for performing one operation in column 502 of this acquired control procedure table 304, with respect to the household device indicated by the ID of the variable This, is transmitted to a control device via the protocol conversion unit 309 and the external communication unit 206. It should be noted that the transmission-destination control device in this example is the second server device, which is the acquisition route for the device ID “12345678”. Furthermore, specifically, this control request is executed by transmitting commands in a command list 520A depicted in the right of FIG. 5A. If the device type is a light, commands in a command list 520B depicted in the right of FIG. 5B are transmitted.

The protocol conversion unit 309 performs mutual conversion between the control requests handled by the control procedure execution unit 308, the device state comparison unit 307, and the device registration determination unit 306 of the integration server device 105 and control requests suitable for the control protocols of the control devices. The control requests handled by the control procedure execution unit 308, the device state comparison unit 307, and the device registration determination unit 306 are commands indicating abstract control content that is not dependent upon a control protocol used by a control device, and, hereinafter, are also referred to as abstract commands. In contrast, the commands handled by the control devices are dependent upon the control protocol used by the control device in question, and, hereinafter, are also referred to as specific commands in contrast to abstract commands.

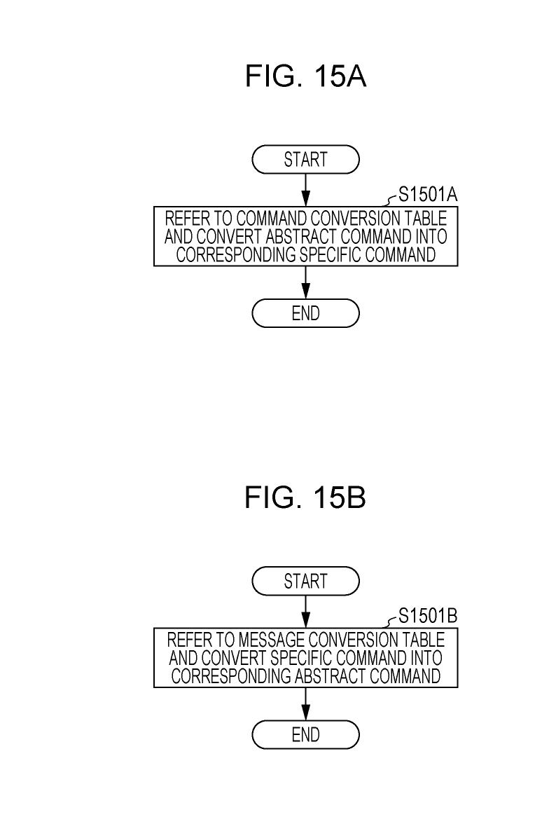

A flowchart for this conversion by the protocol conversion unit 309 is depicted in FIG. 15A. FIG. 15A is a procedure for converting control requests (abstract commands) handled by the control procedure execution unit 308, the device state comparison unit 307, and the device registration determination unit 306, into control requests (specific commands) for the first server device 108 and the second server device 109.

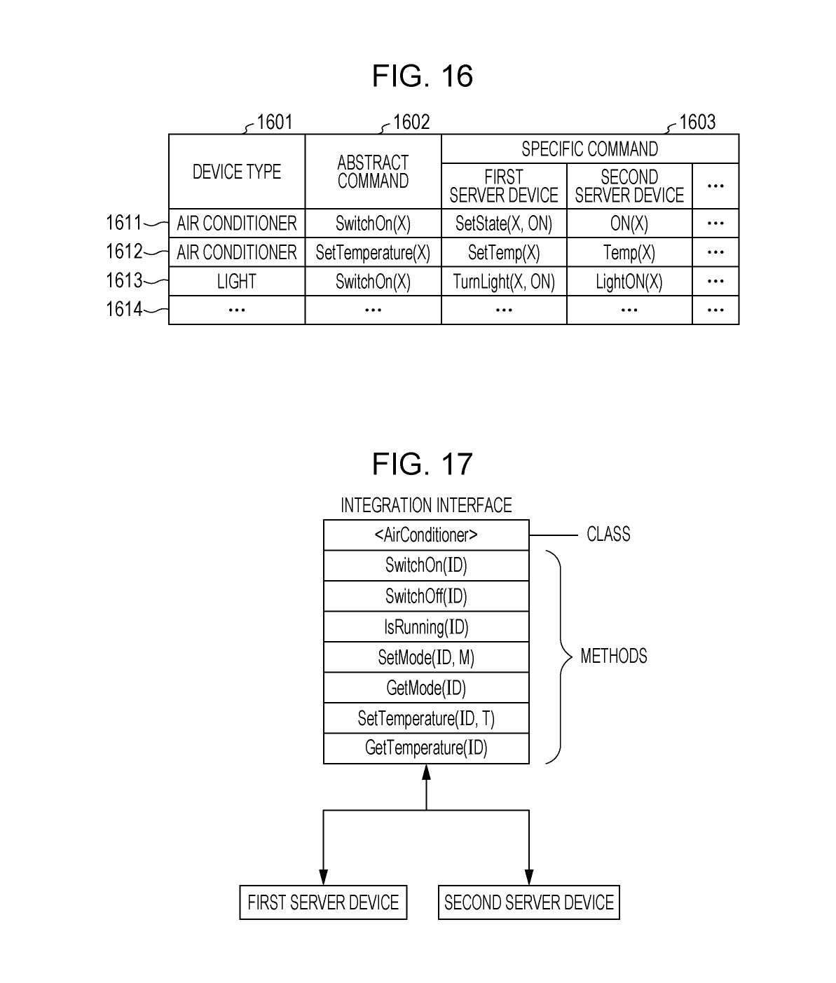

The protocol conversion unit 309 refers to the command conversion table to convert abstract commands into specific commands (step S1501A). An example of this command conversion table is depicted in FIG. 16.

Column 1601 contains device types, column 1602 contains abstract commands, and column 1603 contains specific commands. In column 1602 and column 1603, the letter X signifies a variable and the same value is entered to the same variable, the control-target device ID for example. The protocol conversion unit 309 receives, for example, information indicating the control device that is the destination, and a “SwitchOn(X)” abstract command. Reference is made to column 1602 in the command conversion table to search for a matching abstract command, and reference is made to a column corresponding to the control device that is the destination in the row that includes this abstract command to perform conversion into “SetState(X, ON)”, “ON(X)”, or the like (step S1501A).

Furthermore, information (control responses) relating to the state of each household device or the like received by the integration server device 105 via each control device is dependent upon the control protocol used by the control device, and, hereinafter, this information is also referred to as a specific message. The protocol conversion unit 309 converts a specific message into an abstract message, which is abstract information that is not dependent upon a control protocol, in such a way that the content of the specific message can be handled by the device state comparison unit 307 and the device registration determination unit 306. FIG. 15B depicts an example procedure for converting a control response (specific message) from the first server device 108 and the second server device 109 into a control response (abstract message) that is handled by the device state comparison unit 307 and the device registration determination unit 306. The protocol conversion unit 309, when having received a specific message from a control device, first, refers to a column corresponding to the control device that is the transmission source of the specific message in a message conversion table to search for a matching specific message. Reference is then made to an abstract command in the row that includes this specific command to perform conversion into an abstract message (step S1501B). This abstract command after conversion is transmitted from the protocol conversion unit 309 to the device state comparison unit 307 or the device registration determination unit 306. It should be noted that the message conversion table may be integrated with the command conversion table depicted in FIG. 16 or may be a separate table.

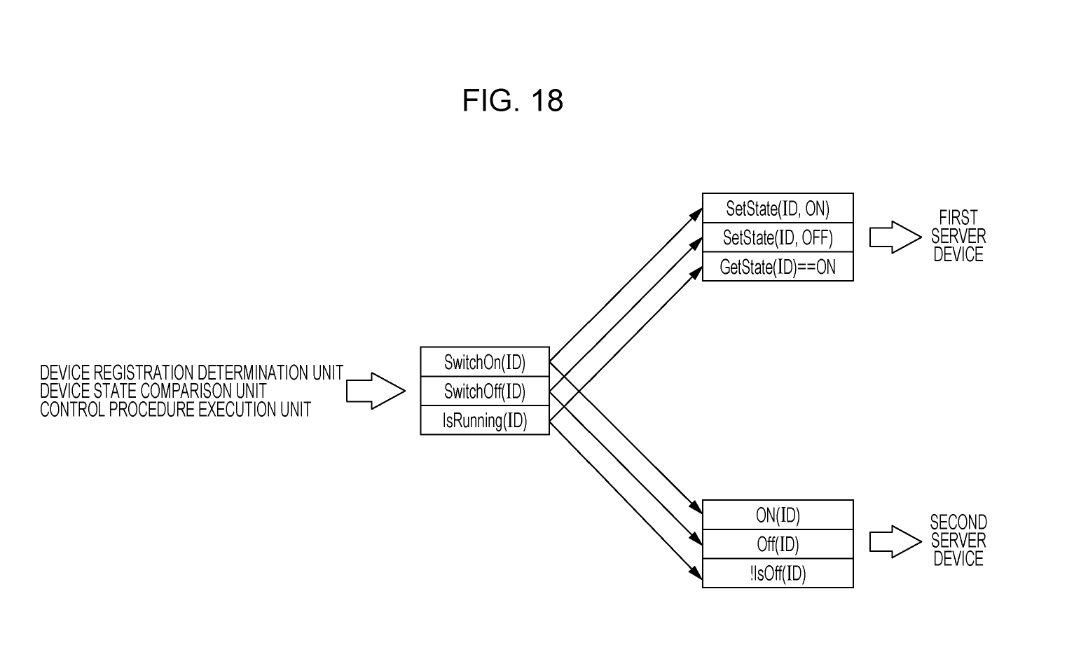

In this way, the device state comparison unit 307, the control procedure execution unit 308, and the device registration determination unit 306 can use the protocol conversion unit 309 as an integration interface to transmit control requests to a plurality of control devices and receive control responses from the plurality of control devices. An implementation example of an integration interface in this kind of protocol conversion unit 309 in the case of an air conditioner is depicted in FIG. 17. In the protocol conversion unit 309, various types of methods are prepared under an air conditioner class (<AirConditioner> in the drawing). The protocol conversion unit 309 having received these as abstract commands refers to the command conversion table and performs conversion into specific commands corresponding to each control device. FIG. 18 depicts an example of conversion into specific commands corresponding to each control device with reference being given to the command conversion table of FIG. 16.

As described above, the integration server device 105 is able to perform control for determining device IDs with differences in control protocols among the control devices of each vendor being absorbed. Furthermore, it is also possible to present the user with an interface in which a plurality of control devices are unified by being substituted or represented, and it is also possible to control a household device using a plurality of routes that are different for each control device, as is conventionally the case.

The continuation of the procedure that the verification control unit 302 causes the control procedure execution unit 308 and the device state comparison unit 307 to execute will be described with reference to FIG. 14 once again.

Next, the verification control unit 302 causes the device state comparison unit 307 to acquire state information indicating the state of the household device indicated by the device ID of This (step S1404). The state information indicating the state of the household device indicated by the device ID of This is also referred to as first state information hereinafter.

The state information referred to here is the operation state (on, off), the continuous operation time, or the like of the household device, and may also be information relating to a setting corresponding to the device type of the household device or data acquired by a sensor provided in the device, such as the operation mode (cooling, heating, automatic, dehumidifying, or the like), temperature, air flow direction, air flow quantity, or the like in the case of an air conditioner, for example, or the brightness (ratio to maximum output), color temperature, or the like in the case of a light.

Describing step S1404 in detail according to the abovementioned example, the device state comparison unit 307, under the control of the verification control unit 302, transmits a command for a state information request corresponding to the “air conditioner” device type via the external communication unit 206 and the protocol conversion unit 309. The transmission destination therefor is the second server device, which is the acquisition route for the device ID “12345678” as in step S1403. Furthermore, the state information request may request all information that can be acquired in relation to the state of the household device, or may request only information relating to the state of the device that corresponds to the control request in step S1403. The device state comparison unit 307 then acquires state information of the air conditioner indicated by the device information ID “12345678” via the external communication unit 206 and the protocol conversion unit 309, as a message for a control response to this state information request.

Next, the verification control unit 302 causes the acquisition of state information indicating the state of the household device indicated by the device ID of That via the external communication unit 206 and the protocol conversion unit 309 (step S1405). The state information indicating the state of the household device indicated by the device ID of That is also referred to as second state information hereinafter. The content of step S1405 is the same as that of step S1404 except for the transmission destination of the command for the state information request being the first server device, which is the acquisition route for the device ID “tE2AEF” and is different from that in step S1403 and step S1404.

Next, the device state comparison unit 307 compares the household device states acquired by way of the plurality of routes and determines whether these are corresponding (step S1406). Specifically, the device state comparison unit 307 verifies the first state information acquired in step S1404 and the second state information acquired in step S1405 against one another.

It should be noted that “corresponding” referred to here is when the state of the household device indicated by the first state information and the state of the household device indicated by the second state information match, such as when, in the case where the device types are air conditioners for example, both of the abovementioned first state information and the second state information indicate that the power is on or indicate that the household devices are in the same operation mode (cooling, heating, automatic, dehumidifying, or the like). If the household device is a device for lighting with which it is possible for the color setting to be changed, the case where the first state information and the second state information are both color settings indicating a daytime white color is feasible.

Furthermore, in the case where the first state information and the second state information are information regarding numerical values, “corresponding” may be determined if an absolute value for the difference between the numerical values is within a predetermined value despite the numerical values not completely matching. For example, in the case where the household devices are air conditioners, when the first state information indicates 28.0° C. as an indoor temperature and the second state information indicates 28.5° C. as an indoor temperature, it may be determined that they are corresponding despite the absolute value indicating a difference of 0.5. Thus, there may be changes due to time differences in the case where values are acquired by sensors, for example. That is, here, “corresponding” expresses not only a complete match of the state indicated by the first state information and the state indicated by the second state information but also includes a state in which there can be deemed to be a substantial match.

It should be noted that it is desirable for the abovementioned step S1403 to step S1405 to be carried out within an extremely short time. This is because there are cases where control according to a determination made by a user at home or a service for a household device or control device or the like may be implemented and the state of a device may change between a control request for an identity determination and the acquisition of states or during the acquisition of states by way of each route, and because, in the case of values that are acquired by sensors as described above, there may be a change in the state surrounding or within a household device acquired by a sensor if a time difference occurs.

In the case where the states of the household devices acquired by way of the plurality of routes do not correspond (“no” in step S1406), it is determined that the device ID of This and the device ID of That indicate different devices and the comparison of the states ends. In the case where the states of the household devices acquired by way of the plurality of routes correspond (“yes” in step S1406), the control procedure execution unit 308 causes the control procedure execution unit 308 and the device state comparison unit 307 to execute step S1403 to step S1407 with regard to control for the next row of the control procedure table 304. Thereafter, this comparison of states is repeated until “no” is determined in step S1406 or the device ID of the final row of the control procedure table 304 is used to execute step S1403 to step S1407. In other words, a transition in the state of the device indicated by the device ID of This and a transition in the state of the device indicated by the device ID of That are acquired by way of the different routes and compared. In the case where the state indicated by the device ID of This and the state indicated by the device ID of That correspond even with device IDs of the final row of the control procedure table 304, the device state comparison unit 307 determines that the device ID of This and the device ID of That indicate the same device and the comparison of the states ends.

The continuation of the procedure that the verification control unit 302 causes the control procedure execution unit 308 and the device state comparison unit 307 to execute will be described with reference to FIG. 12 once again.

In step S1205, in the case where it is determined that the two IDs indicate the same device (“yes” in step S1206), the device state comparison unit 307 updates the device table 303 via the device table creation unit 305 as registered device IDs and IDs that indicate the same device (step S1207). In this case, the IDs of the detected device information are added to the registered device ID list 403 in the i^{th} row. In the abovementioned example, in the case where it is determined that the unregistered device ID “tE2AEF” and the registered device ID “12345678” indicate the same device, the device ID “tE2AEF” is added in the blank section of column 403A in row 411 in FIG. 4.

In the case where “no” is determined in step S1203 or step S1206, the verification control unit 302 repeats step S1203 to step S1206 with respect to the next row of the device table 303. In the case where this is repeated with respect to all of the rows yet there is no device ID for which “yes” is determined in step S1206, the device state comparison unit 307 updates the device table 303 via the device table creation unit 305 as an ID that indicates a new household device (step S1207). In this case, the device table creation unit 305 adds and registers the device type and the unregistered device ID in a new row of the device table 303, row 414 in the example in FIG. 4.

When the device control for determining the identity of a household device indicated by a device ID ends according to the above procedure, the verification control unit 302 instructs the control terminal 101 via the user notification unit 301 to notify the user of the end of the device control for identifying the identity of the household device indicated by the device ID (step S1208). In the abovementioned example, the control terminal 101 having received the instruction ends the notification displayed on the output unit 103 (step S1210). Alternatively, the verification control unit 302 may transmit an end message as a notification, and cause the end message to be presented to the user by means of the control terminal 101.

According to the above procedure, the device management unit 205B determines the identity of a household device indicated by a device ID. Thus, the integration server device 105 is able to determine whether or not devices indicated by different device IDs acquired from a plurality of routes that include different control devices are the same. Furthermore, by saving this determination result and controlling household devices on the basis thereof, it is possible to prevent the occurrence of competition between control requests made via a plurality of routes with respect to the same household device.

### MODIFIED EXAMPLES

An aspect of the present disclosure has been described with an embodiment serving as a specific example as described above; however, the present disclosure is not restricted to the abovementioned embodiment. Various types of modifications are feasible in the abovementioned embodiment. Examples thereof are given hereinafter.

### Modified Example Relating to Control for Identity Determination

Hereinabove, the control procedure execution unit 308 transmitted each of the control procedures given in the control procedure table 304, as control requests to a household device and caused the control procedures to be executed (FIG. 14, steps S1402 to S1407). At such time, the control requests may differ according to the state of the household device prior to the identity determination being executed. Specifically, the state of the device indicated by the device ID of This is acquired prior to a control request for identity determination being transmitted (prior to step S1402 or step S1403 being executed), and the content of the control requests in step S1402 to step S1407 is changed according thereto.

For example, in the case of an air conditioner that is currently being used, that is turned on in other words, the control request for identity determination does not include content indicating that the air conditioner is to be turned off. A control request with which a set temperature or airflow direction setting is altered is therefore implemented. Alternatively, if a heating operation is being implemented, a control request with which this is switched to a cooling operation is not implemented. In this way, it is possible to avoid a control request having content with which inconvenience or discomfort is forced upon the user. Furthermore, with regard to a scenario in which a household device, an air conditioner for example, is switched from on to off or from a heating operation to a cooling operation and then returned to the heating operation and used, and a scenario in which the set temperature, air flow direction, or air flow quantity is altered and then the setting is returned to the original set temperature or the like and used, power consumption is lower in the latter scenario. However, the latter scenario can also be used in the same way as the former scenario as determination criteria for confirming the state of a household device. Consequently, it is possible to suppress an increase in the power consumed by a device following control for determining an identity. This kind of avoidance of control that competes with the current state is realized as described hereinafter, for example.

First, the device state comparison unit 307 having received a device type and the This variable confirms the current state of the household device indicated by the device ID of This prior to step S1402 or step S1403 being executed. The confirmed state of the household device is notified to the control procedure execution unit 308. This current state is an example of third state information in the present embodiment. Then, in the case where that state competes with the operation in column 502 in the i^{th} row, the control procedure execution unit 308 skips the operation and determines whether or not there is any competition with regard to the operation in the next row. If the operation does not compete with the state, a control request for that operation is transmitted. Alternatively, a plurality of types of control procedure tables 304 corresponding to device states may be prepared in advance for each device type of the household devices. The control procedure execution unit 308 selects a suitable control procedure table 304 according to the notified state.

Furthermore, the abovementioned third state information may be used to restore the original state of a household device by means of the integration server device 105. That is, after at least up to the reception of information relating to the state of the household device in steps S1404 and S1405 has been executed, the verification control unit 302 causes a control request for returning the household device indicated by the device ID of This to the state indicated by the third state information, namely the state prior to the execution of control for identity determination, to be transmitted from the control procedure execution unit 308 to the household device. It is thereby possible to restore a household device from a state caused by device control that is not intended by the user and has been executed in order to determine an identity, to a state brought about by control implemented by the user prior to the determination. The device indicated by the device ID of That may also be similarly restored to the original state thereof.

### Modified Example Relating to Verification/Comparison for Identity Determination

For example, in the abovementioned embodiment, in order to determine the identity of a device indicated by a device ID, a household device is controlled and the state of the household device is acquired by way of one route, the state of a household device belonging to the same type is acquired by way of another route, and the states of the household devices acquired by way of both routes are compared (FIG. 14, steps S1403 to S1405). In addition to this, control may be performed such that the routes are additionally switched, for example, and the states of the household devices acquired by way of both routes may be compared. It is thereby possible to determine the identity of the device indicated by a device ID with greater certainty.

Furthermore, in addition to or in substitution of comparing the states of household devices acquired by way of a plurality of routes, the content of a control request to a household device and the state of the household device serving as a result of that control request having been executed may be compared. For example, the state relating to the power source of a household device may be acquired after the power source has been turned on due to a control request. Furthermore, in this case, instead of confirming the state in the route used for the control request, a control request may be issued by way of one route, state information may be acquired by way of another route, and the control request and the state information may be verified against one another. Furthermore, the control request may be transmitted and the state information acquired with the route being additionally switched, and the control request and the state information may be verified against one another.

It should be noted that a setting may be implemented without always using a designated value of a control request but instead using a neighboring value of the designated value according to a determination made by the household device side, as with a temperature setting, for example. In a case such as this, in the comparison between the control request and the state information, a correspondence may be determined if an absolute value for the difference between numerical values is within a predetermined value as described in the embodiment.

### Modified Example Relating to Notification to the User

A notification is issued to the user when control for determining the identity of a device indicated by a device ID is started and prior to the end thereof (FIG. 12, steps S1209 to S1210). The user who receives this notification is not restricted to the user who has received the device registration page transmitted in step S601 and performed an operation that triggers a start request transmission. For example, all users of a user household in which control for this identity determination is performed may be targets for notification. Thus, when control for identity determination is performed for any of the household devices in different rooms within the user household, it is possible to prevent causing a sense of uneasiness for the users in each room, for example. Such notifications can be realized by additionally registering the numbers, addresses, or the like of terminals other than the control terminal 101 as transmission destinations for notifications, as information associated with users in the user management unit 204, for example, and transmitting notifications to these registered terminals in addition to the control terminal 101 in step S1201 and step S1208. Possible examples of such terminals other than the control terminal 101 are mobile terminals such as smartphones and tablets, and also a variety of devices within a user household that are provided with an output unit for outputting images or audio, such as televisions, intercoms, and operation panels for hot water supply systems.

### Modified Example Relating to the Overall System Configuration

In the device control system 100 in the abovementioned embodiment, the integration server device 105, the first server device 108, and the second server device 109 are described as separate server devices in a cloud; however, the form of the device control system 100 is not restricted thereto. For example, the control devices, both of the first server device 108 and the second server device 109 in other words, may be combined.

### [Others]

It should be noted that, in the abovementioned embodiment and modified examples, the device management apparatus and the constituent elements thereof may be configured by using dedicated hardware, may be realized by executing a software program suitable for the constituent elements, and may also be realized as a cloud computing system operated in a distributed manner by a plurality of computers. The constituent elements may be realized by a program execution unit such as a CPU or a processor reading out and executing a software program recorded in a recording medium such as a hard disk or a semiconductor memory. Here, a software program that realizes device management including device identification of the abovementioned embodiment is a program such as the following.

The program is a program that causes a computer to function as a device management apparatus that is connected to a plurality of control devices that control one or more devices and identifies the identities of the devices controlled by the plurality of control devices, the computer being made to: transmit a control request for controlling at least one of the devices to a first control device that is one of the plurality of control devices; receive, from the first control device, a first device identifier that identifies a device controlled according to the control request and first state information that identifies the state of said device; receive, from a second control device that is different from the first control device from among the plurality of control devices, a second device identifier that identifies a device connected to the second control device and second state information that identifies the state of said device; verify the first state information and the second state information against one another; and, when the state of the device indicated by the first state information and the state of the device indicated by the second state information correspond, determine that the device indicated by the first device identifier and the device indicated by the second device identifier are the same.

A device management method and a device management apparatus according to one or more aspects has been described hereinabove on the basis of an embodiment; however, the present disclosure is not limited to this embodiment. Modes in which various modifications conceived by a person skilled in the art have been implemented in the present embodiment, and modes constructed by combining the constituent elements in different embodiments may also be included within the scope of one or more aspects provided they do not depart from the purpose of the present disclosure.

In the control of home appliances implemented via a cloud, the present disclosure can be usefully utilized for the control and management of home appliances in the case where there is a device management apparatus that integrates a plurality of control devices in the cloud.

What is claimed is:

1. A management method for a management device connected to a first control device and a second control device, the management method comprising:
transmitting a first command to the first control device for causing a first device to execute a predetermined operation, the first device being controlled by the first control device;
transmitting a second command to the first control device for causing the first device to transmit first information indicating a state of the first device after the predetermined operation has been executed;
receiving the first information from the first control device;
transmitting a third command to the second control device for causing a second device to transmit second information indicating a state of the second device;
receiving the second information from the second control device;
comparing the first information and the second information;
determining the first device is the second device when the state of the second device indicated by the second information corresponds to the state of the first device indicated by the first information; and
storing, in a memory, third information indicating the first device is controlled by the first control device and the second control device when the first device is determined to be the second device.

2. The management method according to claim 1,
wherein the first device is controlled by the first control device through a first protocol, and
the second device is controlled by the second control device through a second protocol different from the first protocol.

3. The management method according to claim 1,
wherein the first information includes a first value,
the second information includes a second value, and
the first device is determined to be the second device when an absolute value of a difference between the first value and the second value is within a predetermined range.

4. The management method according to claim 1,
wherein fourth information indicating an initial state of the first device is received before the first command is transmitted, and
a fourth command for causing the first device to be restored to the initial state indicated by the fourth information is transmitted to the first control device after at least the first information has been received.

5. The management method according to claim 1,
wherein fourth information indicating an initial state of the first device is received before the first command is transmitted, and
the predetermined operation is decided based upon the initial state indicated by the fourth information.

6. The management method according to claim 1,
wherein a user terminal associated with the first device is notified of the first device executing the predetermined operation, before the first command is transmitted.

7. The management method according to claim 1,
wherein the memory stores fourth information in advance, and
the fourth information indicates a device connected to the management device and, in addition, indicates that the device connected to the management device is controlled by at least one of the first control device and the second control device.

8. The management method according to claim 1,
wherein the memory stores a table,
the table includes a relationship between the first device, a first ID of the first device, and a second ID of the second device,
the first ID is provided by the first control device and indicates that the first device is controlled by the first control device,
the second ID is provided by the second control device and indicates that the second device is controlled by the second control device,
the first ID is provided prior to the transmitting of the first command, and
the second ID is provided after the determining.

9. The management method according to claim 7,
wherein a fourth command for causing transmission of fifth information is transmitted to the first control device, the fifth information indicating devices controlled by the first control device,
the fifth information is received from the first control device,
the fourth information and the fifth information are compared, and
the first command is transmitted when the first device is not included in the fourth information as a device controlled by the first control device.

10. The management method according to claim 9,
wherein the fifth information additionally indicates types of the devices controlled by the first control device, and
when the first device is included in a first type, the predetermined operation is decided based upon the first type.

11. A management device connected to a first control device and a second control device, the management device comprising:
a transmitter that:
transmits a first command to the first control device for causing a first device to execute a predetermined operation, the first device being controlled by the first control device;
transmits a second command to the first control device for causing transmission of first information indicating a state of the first device after the predetermined operation has been executed; and
transmits a third command to the second control device for causing transmission of second information indicating a state of the second device;
a receiver that receives the first information from the first control device, and receives the second information from the second control device;
a processor that compares the first information and the second information, and determines the first device is the second device when the state of the second device indicated by the second information corresponds to the state of the first device indicated by the first information; and
a memory that stores third information indicating the first device is controlled by the first control device and the second control device when the processor determines the first device is the second device.

12. A non-transitory recording medium having recorded thereon a program that causes a processor to execute processes including:
transmitting a first command to the first control device for causing a first device to execute a predetermined operation, the first device being controlled by the first control device;
transmitting a second command to the first control device for causing the first device to transmit first information indicating a state of the first device after the predetermined operation has been executed;
receiving the first information from the first control device;
transmitting a third command to the second control device for causing a second device to transmit second information indicating a state of the second device;
receiving the second information from the second control device;
comparing the first information and the second information;
determining the first device is the second device when the state of the second device indicated by the second information corresponds to the state of the first device indicated by the first information; and
storing, in a memory, third information indicating the first device is controlled by the first control device and the second control device when the first device is determined to be the second device.
